(19) United States
(12) Patent Application Publication
(10) Pub. No.: US 2016/0047308 A1
(43) Pub. Date: Feb. 18, 2016

(54) MECHANICAL DRIVE ARCHITECTURES WITH LOW-LOSS LUBRICANT BEARINGS AND LOW-DENSITY MATERIALS

(71) Applicant: General Electric Company, Schenectady, NY (US)

(72) Inventors: David Lee Williamson, Greer, SC (US); Carlos Eduardo Silva, Greenville, SC (US); Raymond John Bankert, Simpsonville, SC (US)

(73) Assignee: General Electric Company

(21) Appl. No.: 14/460,418

(22) Filed: Aug. 15, 2014

(51) Int. Cl. F02C 7/06; F02C 3/10; F02C 7/36

(52) U.S. Cl. CPC F02C 7/06; F02C 7/36; F02C 3/10

(57) ABSTRACT

Mechanical drive architectures can include a gas turbine having a compressor section, a turbine section, and a combustor section. A load compressor is driven by the gas turbine. A rotor shaft extends through the gas turbine and the load compressor. At least one of the rotating components in one of the gas turbine and the load compressor includes a low-density material. Bearings support the rotor shaft within the gas turbine and the load compressor, at least one of the bearings being a low-loss lubricant bearing.

### CROSS-REFERENCE TO RELATED APPLICATIONS

This patent application is related to the following commonly-assigned patent applications: U.S. Ser. No. 14/______ (Attorney Docket No. 257269-1), entitled “MULTI-STAGE AXIAL COMPRESSOR ARRANGEMENT”; U.S. Ser. No. 14/______ (Attorney Docket No. 261580-1), entitled “POWER TRAIN ARCHITECTURES WITH MONO-TYPE LOW-LOSS BEARINGS AND LOW-DENSITY MATERIALS”; U.S. Ser. No. 14/______ (Attorney Docket No. 267305-1), entitled “POWER TRAIN ARCHITECTURES WITH HYBRID-TYPE LOW-LOSS BEARINGS AND LOW-DENSITY MATERIALS”; U.S. Ser. No. 14/______ (Attorney Docket No. 271508-1), entitled “MECHANICAL DRIVE ARCHITECTURES WITH MONO-TYPE LOW-LOSS BEARINGS AND LOW-DENSITY MATERIALS”; U.S. Ser. No. 14/______ (Attorney Docket No. 27509-1), entitled “MECHANICAL DRIVE ARCHITECTURES WITH HYBRID-TYPE LOW-LOSS BEARINGS AND LOW-DENSITY MATERIALS”; and U.S. Ser. No. 14/______ (Attorney Docket No. 276988-1), entitled “POWER TRAIN ARCHITECTURES WITH LOW-LOSS LUBRICANT BEARINGS AND LOW-DENSITY MATERIALS.” Each patent application identified above is filed concurrently herewith and is incorporated by reference herein.

### BACKGROUND

The present invention relates generally to mechanical drive gas turbines, and more particularly, to mechanical drive architectures that can have low-loss lubricant bearings and low-density materials.

Gas turbines are used in many sectors of industry, from military to power generation. Typically, gas turbines are used to produce electrical energy. However, some gas turbines are used to propel various vehicles, airplanes, ships, etc. In the oil and gas field, gas turbines can be used to drive compressors, pumps and/or generators. In a scenario in which a gas turbine is used to drive a compressor in an industrial application (e.g., for injecting gas into a well to force oil up through another bore), the compressor of the gas turbine compresses air with rows of rotating blades and stationary vanes, directing it to a combustor that mixes the compressed air with fuel, and burns it to form a hot air-fuel mixture that is expanded through blades in a turbine of the gas turbine. As a result, the blades spin or rotate about a shaft or rotor of the gas turbine. The spinning or rotating rotor drives the load compressor connected to the gas turbine, which uses the rotational energy to compress a fluid (e.g., gas, air, etc.).

Many gas turbine architectures that are used in mechanical drive architectures employ slide bearings in conjunction with a high viscosity lubricant (i.e., oil) to support the rotating components of the turbine section, the compressor section, and the load compressor connected thereto. Oil bearings are relatively inexpensive to purchase, but have costs associated with their accompanying oil skids (e.g., for pumps, reservoirs, accumulators, etc.). In addition, oil bearings have high maintenance intervals and can cause excessive viscous losses in the drive train, which in turn can adversely affect operation of a gas turbine-driven load compressor unit.

### SUMMARY

In one aspect of the present invention, a mechanical drive architecture is disclosed. In this aspect of the present invention, the mechanical drive architecture comprises a gas turbine having a compressor section, a turbine section, and a combustor section operatively coupled to the compressor section and the turbine section. A load compressor is driven by the gas turbine. A rotor shaft extends through the compressor section and the turbine section of the gas turbine engine and the load compressor. Each of the compressor section, the turbine section, and the load compressor include a plurality of rotating components, at least one of the rotating components in one of the gas turbine and the load compressor including a low-density material. A plurality of bearings support the rotor shaft within the gas turbine and the load compressor, wherein at least one of the bearings is a low-loss bearing having a low-loss lubricant.

### BRIEF DESCRIPTION OF THE DRAWINGS

Features and advantages of the present invention will be apparent from the following more detailed description of the preferred embodiments, taken in conjunction with the accompanying drawings that illustrate, by way of example, the principles of the invention.

FIG. 1 is a schematic diagram of a mechanical drive architecture including a front-end drive gas turbine, a load compressor, and a bearing fluid skid, and further including at least one low-loss bearing having a low-loss lubricant and at least one rotating component made of a low-density material, according to an embodiment of the present invention;

FIG. 2 is a schematic diagram of a mechanical drive architecture including a front-end drive gas turbine having a reheat section, a load compressor, and a bearing fluid skid, and further including at least one low-loss bearing having a low-loss lubricant and at least one rotating component made of a low-density material, according to an embodiment of the present invention;

FIG. 3 is a schematic diagram of a mechanical drive architecture including a rear-end drive gas turbine, a load compressor, and a bearing fluid skid, and further including at least one low-loss bearing having a low-loss lubricant and at least one rotating component made of a low-density material, according to an embodiment of the present invention;

FIG. 4 is a schematic diagram of a multi-shaft mechanical drive architecture including a rear-end drive gas turbine, a load compressor, a bearing fluid skid, and a gearbox, and further including at least one low-loss bearing having a low-loss lubricant and at least one rotating component made of a low-density material, according to an embodiment of the present invention;

FIG. 5 is a schematic diagram of a gas turbine architecture including a rear-end drive power turbine and further including at least one low-loss bearing having a low-loss lubricant and at least one rotating component made of a low-density material, according to an embodiment of the present invention;

FIG. 6 is a schematic diagram of a gas turbine architecture including a rear-end drive power turbine and a reheat section and further including at least one low-loss bearing having a low-loss lubricant and at least one rotating component made of a low-density material, according to an embodiment of the present invention;

FIG. 7 is a schematic diagram of a front-end drive gas turbine architecture including a stub shaft and a speed-reducing mechanism to reduce the speed of forward stages of a compressor in the gas turbine engine and further including at least one low-loss bearing having a low-loss lubricant and at least one rotating component made of a low-density material, according to an embodiment of the present invention;

FIG. 8 is a schematic diagram of a front-end drive gas turbine architecture including a stub shaft and a speed-reducing mechanism to reduce the speed of forward stages of a compressor in the gas turbine engine, a reheat section, at least one low-loss bearing having a low-loss lubricant, and at least one rotating blade made of a low-density material, according to an embodiment of the present invention;

FIG. 9 is a schematic diagram of a multi-shaft, front-end drive gas turbine architecture including a low pressure compressor section coupled to a low pressure turbine section via a low-speed spool and a high pressure compressor section coupled to a high pressure turbine section via a high-speed spool, and further including at least one low-loss bearing having a low-loss lubricant and at least one rotating blade made of a low-density material in use with the drive train, according to an embodiment of the present invention.

### DETAILED DESCRIPTION

As mentioned above, many mechanical drive architectures employ slide bearings in conjunction with a high viscosity lubricant (i.e., oil) to support the rotating components of the gas turbine, the generator, and the load compressor connected thereto. Oil bearings have high maintenance interval costs and cause excessive viscous losses into the drive train, which can adversely affect operation of a load compressor driven by the gas turbine. There are also costs associated with the oil skids that accompany the oil bearings.

Low-loss bearings—including bearings having a low-loss lubricant—are one alternative to the use of oil bearings. However, certain gas turbine-driven mechanical drive architectures are difficult applications for the use of low-loss bearings. Specifically, as gas turbine sizes increase, the support bearing pad area increases as a square of the rotor shaft diameter, while the weight of the mechanical drive architecture increases as a cube of the rotor shaft diameter. Therefore, to implement low-loss bearings, the increase in the bearing pad area and the increase in the weight should be proportionally equal. Thus, it is desirable to incorporate light-weight or low-density materials for the mechanical drive architecture, which help promote the desired proportionality.

In addition to creating a mechanical drive architecture having a weight supportable by low-loss bearings, the use of lighter weight materials can also promote the ability to produce greater airflows. Heretofore, generating a higher airflow rate in such a drive train has been difficult because the centrifugal loads that are placed on the rotating blades during operation of a gas turbine increase with the longer blade lengths needed to produce the desired airflow rate. For example, the rotating blades in the forward stages of a multi-stage axial compressor used in a gas turbine are larger than the rotating blades in both the mid and aft stages of the compressor. Such a configuration makes the longer, heavier rotating blades in the forward stages of an axial compressor more susceptible to being highly stressed during operation due to large centrifugal pulls induced by the rotation of the longer and heavier blades.

In particular, large centrifugal pulls are experienced by the blades in the forward stages due to the high rotational speed of the rotor wheels, which in turn, stress the blades. The large attachment stresses that can arise on the rotating blades in the forward stages of an axial compressor become problematic as it becomes more desirable to increase the size of the blades in order to produce a compressor for the gas turbine engine that can generate a higher airflow rate as demanded by certain applications. Similar considerations apply to the load compressor as well.

It would be desirable, therefore, to provide a mechanical drive architecture that incorporates one or more low-loss lubricant bearings used in conjunction with low-density materials, as applied in gas turbines or load compressors. In some embodiments, such low-loss bearings are used in conjunction with components made of low-density materials. Such architectures provide fewer viscous losses, thereby increasing the overall efficiency of the mechanical drive architecture.

Various embodiments of the present invention are directed to providing gas turbine-driven mechanical drive architectures with low-loss lubricant bearings and low-density materials.

As used herein, the phrase “mechanical drive architecture” describes an assembly of moving parts, which includes the rotating components of one or more of a compressor section, a turbine section, a reheat turbine section, a power turbine section, and a load compressor section, which collectively communicate with one another to compress a fluid. The phrases “mechanical drive architecture,” “mechanical drive train,” and “gas turbine-driven mechanical drive” may be used interchangeably. The phrase “gas turbine architecture” describes a system having a compressor section, a combustor section, and a turbine section, and which may optionally include a reheat combustor section, a reheat turbine section, and/or a power turbine section. The gas turbine architecture is a subset of the mechanical drive architectures described herein.

As used herein, a “low-loss bearing” is a bearing assembly having at least one primary bearing unit, which has a working fluid that has a low or very low viscosity. The “primary bearing unit” may be a journal bearing, a thrust bearing, or a journal bearing adjacent a thrust bearing. A “low-loss lubricant bearing” or a “low-low loss bearing including a low-loss lubricant” is a bearing assembly in which the working fluid is a low-loss lubricant and which requires no additional secondary bearing.

The phrase “low-loss lubricants,” as used in the present low-loss bearings, refers to fluids having a viscosity much greater than water (i.e., 1 centipoise at 20° C.) and preferably having a viscosity of between approximately VG8 and approximately VG20, where VG represents viscosity grade in centistokes (cSt) at 40° C. on the ISO scale developed by the International Standards Organization. Per ISO standards (set forth in ISO 3448 published in 1992), each viscosity grade is designated by the nearest whole number to its midpoint kinematic viscosity in mm²/second at 40° C. (1 mm²/second=1 cSt), and a range of +/−10 percent of the value is permitted. Specific examples of low-loss lubricants having a viscosity in the range above include mineral oil-based lubricants in the API baseoil group III; synthetic-based polyalphaolefins (PAOs) in the API baseoil group IV; and certain polyalkylene glycols (PAGs). In contrast, “high viscosity” oils (also referred to herein as conventional oils) used in industrial gas turbines may have a viscosity of VG32 or even VG45 for high-temperature environments.

As used herein, a “mono-type low-loss bearing” is a bearing assembly having a single primary bearing unit, which has a very low viscosity working fluid and which is accompanied by a secondary bearing that is a roller bearing element. As used herein, a “hybrid-type low-loss bearing” is a bearing assembly having two primary bearing units, which include a very low viscosity working fluid and which are accompanied by a secondary bearing. Examples of “roller bearing elements” used as the secondary or back-up bearings in mono-type or hybrid-type low-loss bearings include spherical roller bearings, conical roller bearings, tapered roller bearings, and ceramic roller bearings.

U.S. patent application Ser. No. ______, entitled “MECHANICAL ARCHITECTURES WITH MONO-TYPE LOW-LOSS BEARINGS AND LOW-DENSITY MATERIALS”, Attorney Docket No. 271508-1, filed concurrently herewith and incorporated by reference herein, provides more details on the use of mono-type bearings in power generation architectures. U.S. patent application Ser. No. ______, entitled “MECHANICAL DRIVE ARCHITECTURES WITH HYBRID-TYPE LOW-LOSS BEARINGS AND LOW-DENSITY MATERIALS”, Attorney Docket No. 271509-1, filed concurrently herewith and incorporated by reference herein, provides more details on the use of hybrid-type bearings in power generation architectures.

In either mono-type or hybrid-type low-loss bearings, the working fluid(s) may be very low viscosity fluids. Examples of “very low viscosity” fluids used in the present mono-type or hybrid-type low-loss bearings have a viscosity less than water (i.e., 1 centipoise at 20° C.) and may include, but are not limited to: air (e.g., in high pressure air bearings), gas (e.g., in high pressure gas bearings), magnetic flux (e.g., in high flux magnetic bearings), and steam (e.g., in high pressure steam bearings). In a gas bearing, the gaseous fluid may be an inert gas, hydrogen, carbon dioxide (CO₂), nitrogen dioxide (NO₂), or hydrocarbons (including methane, ethane, propane, and the like).

In hybrid-type low-loss bearings, the first primary bearing unit includes a magnetic bearing having magnetic flux as the working fluid. The second primary bearing unit includes a foil bearing supplied with a high pressure fluid having a very low viscosity, examples of which are provided above.

For clarity in illustrating the various drive train architectures, the bearings (regardless of type) are represented with a rectangular symbol and the number 140. Generally speaking, the working fluid provided by the bearing fluid skid to each primary bearing unit is illustrated by an arrow. To represent hybrid-type low-loss bearings, the working fluids provided by the bearing fluid skid to the two primary bearing units are represented in the Figures by two lines with different-shaped arrows. In particular, an arrow with a closed head represents piping delivering the magnetic fluid, while an arrow with an open head represents piping delivering one of the above-mentioned low-loss lubricants or very low viscosity fluids.

Although the Figures may illustrate the hybrid-type low-loss bearings being used in most or all of the sections of the drive train architectures, it is not necessary that all of the bearings be hybrid-type bearings. For example, a combination of low-loss lubricant bearings may be used in conjunction with conventional oil bearings, the low-loss lubricant bearings being used in some locations and the conventional oil bearings being used in other locations. Alternately or in addition, one or more of the bearings may include very low viscosity fluids in either mono-type or hybrid-type low-loss bearings, as long as at least one bearing is a low-loss lubricant bearing. In scenarios where a conventional oil bearing is used at a particular location, it would receive a single fluid (oil) supplied from the bearing fluid skid. In scenarios where a mono-type bearing (containing a very low viscosity fluid) is used, such bearing would likewise receive a single fluid from the bearing fluid skid. Thus, the use of two arrows to each bearing in the accompanying Figures is merely illustrative and is not intended to limit the scope of the disclosure to any particular arrangement (e.g., one using only hybrid-type bearings).

As used herein, a “low-density material” is a material that has a density that is less than about 0.200 lbm/in³. Examples of a low-density material that is suitable for use with rotating components (e.g., blades 130, 135) illustrated in the Figures and described herein include, but are not limited to: composite materials, including ceramic matrix composites (CMCs), organic matrix composites (OMCs), polymer glass composites (PMCs), metal matrix composites (MMCs), and carbon-carbon composites (CCCs); beryllium; titanium (such as Ti-64, Ti-6222, and Ti-6246); intermetallics including titanium and aluminum (such as TiAl, TiAl₂, TiAl₃, and Ti₃Al); intermetallics including iron and aluminum (such as FeAl); intermetallics including platinum and aluminum (such as PtAl); intermetallics including cobalt and aluminum (such as CbAl); intermetallics including lithium and aluminum (such as LiAl); intermetallics including nickel and aluminum (such as NiAl); and nickel foam.

Use of the phrase “the low-density material” in the present application, including the Claims, should not be interpreted as limiting the various embodiments of the present invention to the use of a single low-density material, but rather can be interpreted as referring to components including the same or different low-density materials. For example, a first low-density material could be used in one section of an architecture while a second (different) low-density material could be used in another section. In another example, a first low-density material could be used in one stage of a section (e.g., the turbine section), while a second (different) low-density material could be used in a second stage of the same section (e.g., the turbine section).

In the Figures, the use of low-density materials is represented by a dashed line in the respective section of the drive train where such low-density materials may be used. Although the Figures may illustrate the low-density materials being used in most or all of the sections of the mechanical drive architectures or gas turbine architectures, it should be understood that the low-density materials may be confined to only those sections supported by low-loss bearings.

In contrast to the low-density materials described above, a “high-density material” is a material that has a density that is greater than about 0.200 lbm/in3. Examples of a high-density material (as used herein) include, but are not limited to: nickel-based superalloys (such as alloys in single-crystal, equi-axed, or directionally solidified form, examples of which include INCONEL® 625, INCONEL® 706, and INCONEL® 718); steel-based superalloys (such as wrought CrMoV and its derivatives, GTD-450, GTD-403 Cb, and GTD-403 Cb+); and all stainless steel derivatives (such as 17-4PH® stainless steel, AISI type 410 stainless steel, and the like).

The technical effects of having drive train architectures with low-loss lubricant bearings and low-density materials as described herein are that these architectures: (a) provide the ability to use low-loss bearings in a drive train that would otherwise be too heavy to operate; (b) provide the ability to operate the bearings at acceptable temperatures, while carrying heavy loads, without prematurely degrading the low-loss lubricant bearing fluid; (c) deliver a high output load while reducing viscous losses that are typically introduced into the drive train through the use of high viscosity oil-based bearings; and (d) allow a reduction in the flow and volume of lubricant used by each bearing, thereby permitting a corresponding reduction in the size of the associated lubricant reservoirs, pumps, and the like.

Delivering a larger quantity of airflow by using rotating blades in the gas turbine that include low-density materials translates to a higher output of the gas turbine. As a result, gas turbine manufacturers can increase the size of the rotating blades to generate higher airflow rates, while at the same time ensuring that such longer blades keep within the prescribed inlet annulus (AN²) limits to obviate excessive attachment stresses on the blades, even when the blades are made from low-density materials. Note that AN² is the product of the annulus area A (in²) and rotational speed N squared (rpm²) of a rotating blade, and is used as a parameter that generally quantifies power output rating from a gas turbine.

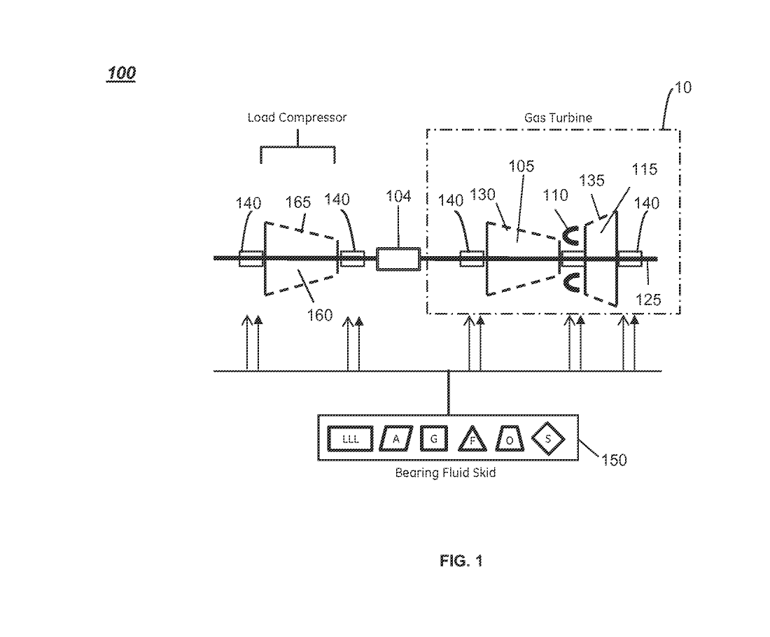

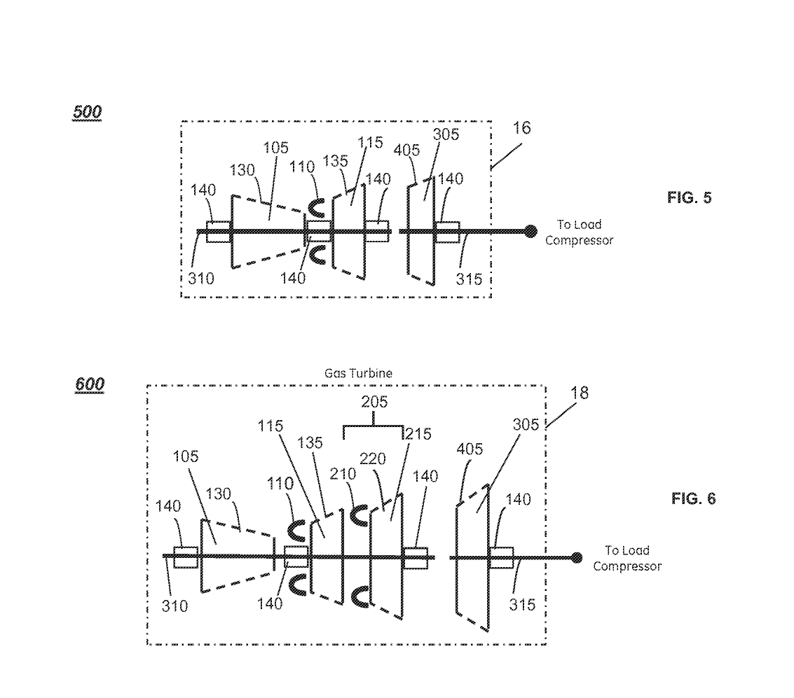

FIGS. 1 through 4 illustrate various mechanical drive architectures including gas turbines, which may include multiple bearing locations. FIGS. 5 through 9 illustrate various gas turbine architectures, which may include multiple bearing locations. Low-loss bearings 140 (especially low-loss lubricant bearings) may be used in any location throughout the drive train, as desired, regardless of the load output of the mechanical drive architecture. It may be advisable to use low-density materials in conjunction with low-loss lubricant bearings, since the larger component size and associated increases in weight with higher load outputs may require the use of low-density materials. In some embodiments, it is contemplated that low-loss lubricant bearings may be used without low-density materials in the rotating components, although improved performance and/or operation may be achieved by using low-density materials for at least some of the rotating components.

In those cases where low-loss bearings are used to support a particular section of the mechanical drive architecture, low-density materials may be used in the particular rotating components of that section of the drive train. For example, if the low-loss bearings are supporting a turbine section, low-density material can be used in one or more of the stages of rotating blades within the turbine section (as indicated by dashed lines). Similarly, if the low-loss bearings are supporting a load compressor, low-density materials can be used in the rotating components of the load compressor (also indicated by dashed lines).

The term “rotating component” is intended to include one or more of the moving parts of a compressor section, a turbine section, a reheat turbine section, a power turbine section, and a load compressor, such as blades (also referred to as airfoils), coverplates, spacers, seals, shrouds, heat shields, and any combinations of these or other moving parts. For convenience herein, the rotating blades of the compressor, the turbine, and the load compressor will be referenced most often as being made of a low-density material. However, it should be understood that other components of low-density material may be used in addition to, or instead of, the rotating blades.

Although the descriptions that follow with respect to the illustrated drive train architectures are for use in a commercial or industrial mechanical drive architecture, the various embodiments of the present invention are not meant to be limited solely to such applications. Instead, the concepts of using low-loss bearings (and particularly, low-loss lubricant bearings) and rotating components of low-density material are applicable to all types of combustion turbine or rotary engines, which use a compressible fluid to drive a load device having either a compressible or nearly incompressible fluid. Examples of load devices using compressible fluids include, but are not limited to, a stand-alone compressor (such as a multi-stage axial compressor arrangement), aircraft engines, marine power drives, and the like. Examples of load devices using nearly incompressible fluids (e.g., water, LNG) include, but are not limited to, pumps, water brakes, screw compressors, gear pumps, and the like.

The various embodiments described herein are not meant to be limited to any particular type of load compressor. Instead, the various embodiments of the invention are suitable for use with any type of load compressor that can be driven by a gas turbine. Examples of gas turbine-driven load compressors that are suitable for use with the various embodiments described herein include, but are not limited to: axial compressors, centrifugal compressors, positive displacement compressors, reciprocating compressors, natural gas compressors, horizontally split compressors, vertically split compressors, integrally geared compressors, double flow compressors, etc. Furthermore, those skilled in the art will appreciate that the various embodiments described herein are also suitable for use with stand-alone compressors that are not driven by a gas turbine.

Referring now to the figures, FIG. 1 is a schematic diagram of a single-shaft, simple cycle gas turbine-driven mechanical drive architecture 100 with a gas turbine 10 and a load compressor 160. At least one low-loss bearing and at least one rotating blade made of a low-density material are used with the drive train, according to an embodiment of the present invention. In one embodiment, at least one low-loss bearing includes a low-loss lubricant.

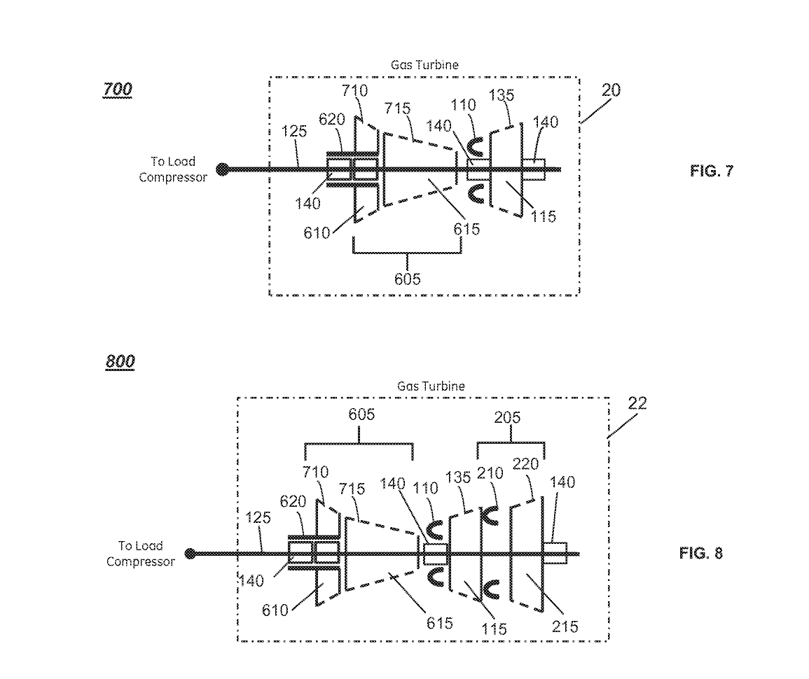

Briefly, as shown in FIG. 1, the gas turbine 10 comprises a compressor section 105, a combustor section 110, and a turbine section 115. The gas turbine 10 is in a front-end arrangement with the load compressor 160, such that the load compressor 160 is located proximate the compressor section 105. Other architectures for the gas turbine 10 may be used, such as those illustrated in FIGS. 7, 8, and 9.

A common rotatable shaft, referred to as rotor shaft 125, couples the compressor section 105, the turbine section 115, and the load compressor 160 along a single line, such that turbine section 115 drives the gas turbine compressor section 105 and the load compressor 160. As shown in FIG. 1, the rotor shaft 125 extends through the turbine section 115, the compressor section 105, and the load compressor 160. In this single-shaft arrangement, the rotor shaft 125 can have a gas turbine compressor rotor shaft part, a turbine rotor shaft part, and a load compressor rotor shaft part coupled pursuant to conventional technology.

Coupling components can couple the turbine rotor shaft part, the gas turbine compressor rotor shaft part, and the load compressor rotor shaft part of the rotor shaft 125 to operate in cooperation with the bearings 140. The number of coupling components and their locations along the rotor shaft 125 can vary by design and application of the mechanical drive architecture.

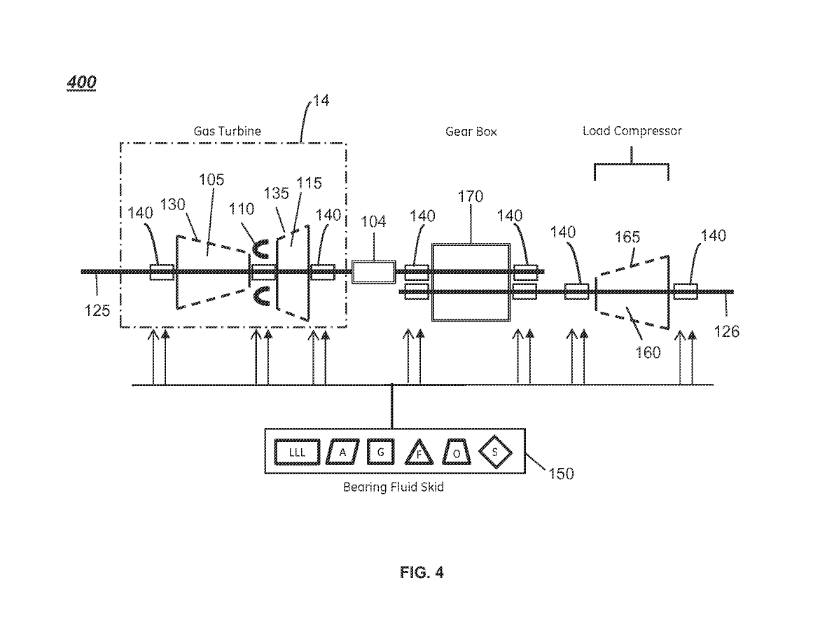

One representative load coupling element 104 is illustrated in FIG. 1 (between the gas turbine 10 and the generator 120), by way of example. Alternately, a clutch (not shown) or a gearbox (170, as shown in FIG. 4) may be used as the load coupling element. In this manner, the respective rotor parts that are coupled to the coupling members are rotatable thereto by respective bearings 140.

The compressor section 105 can include multiple stages of blades 130 disposed in an axial direction along rotor shaft 125. For example, the compressor section 105 can include forward stages of blades 130, mid stages of blades 130, and aft stages of blades 130. As used herein, the forward stages of blades 130 are situated at the front or forward end of the compressor section 105 along rotor shaft 125 at the portion where airflow (or gas flow) enters the compressor section via inlet guide vanes (that is, distal to the combustor section 110). The mid and aft stages of blades are the blades disposed downstream of the forward stages along the rotor shaft 125 where the airflow (or gas flow) is further compressed to an increased pressure (that is, proximate to the combustor section 110). Accordingly, the length of the blades 130 in the compressor section 105 decreases from forward to mid to aft stages.

Each of the stages in the compressor section 105 can include rotating blades 130 arranged in a circumferential array about the circumference of the rotor shaft 125 to define moving blade rows extending radially outward from the rotatable shaft. The moving blade rows are disposed axially along the rotor shaft 125 in locations that are situated in the forward stages, the mid stages, and the aft stages. In addition, each of the stages can include annular rows of stationary vanes (not illustrated) extending radially inward towards the rotor shaft 125 in the forward stages, the mid stages, and the aft stages. In one embodiment, the annular rows of stationary vanes can be disposed on the compressor's casing (not illustrated) that surrounds the rotor shaft 125.

In each of the stages, the annular rows of stationary vanes can be arranged with the moving blade rows in an alternating pattern along an axial direction of the rotor shaft 125 parallel with its axis of rotation. A grouping of a row of stationary vanes and a row of moving blades defines an individual “stage” of the compressor 105. In this manner, the moving blades in each stage are cambered to apply work and to turn the flow, while the stationary vanes in each stage are cambered to turn the flow in a direction best suited to prepare it for the moving blades of the next stage. In one embodiment, the compressor section 105 can be a multi-stage axial compressor.

The turbine section 115 can also include stages of blades 135 disposed in an axial direction along the rotor shaft 125. For example, the turbine section 115 can include forward stages of blades 135, mid stages of blades 135, and aft stages of blades 135. The forward stages of blades 135 are situated at the front or forward end of the turbine section 115 along the rotor shaft 125 at the portion where a hot compressed motive gas, also known as a working fluid, enters the turbine from combustor 110 for expansion. The mid and aft stages of blades are the blades disposed downstream of the forward stages along the rotor shaft 125 where the working fluid is further expanded. Accordingly, the length of the blades 135 in the turbine section 115 increases from forward to mid to aft stages.

Each of the stages in the turbine section 115 can include rotating blades 135 arranged in a circumferential array about the circumference of the rotor shaft 125 to define moving blade rows extending radially outward from the rotatable shaft. Like the stages for the compressor section 105, the moving blade rows of the turbine section 115 are disposed axially along rotor shaft 125 in locations that are situated in the forward stages and the mid and aft stages. In addition, each of the stages can include annular rows of stationary vanes extending radially inward towards the rotor shaft 125 in the forward stages, the mid stages, and the aft stages. In one embodiment, the annular rows of stationary vanes can be disposed on the turbine's casing (not illustrated) that surrounds the rotor shaft 125.

In each of the stages, the annular rows of stationary vanes can be arranged with the moving blade rows in an alternating pattern along an axial direction of the rotor shaft 125 parallel with its axis of rotation. A grouping of a row of stationary vanes and a row of moving blades defines an individual “stage” of the turbine section 105. In this manner, the moving blades in each stage are cambered to apply work and to turn the flow, while the stationary vanes in each stage are cambered to turn the flow in a direction best suited to prepare it for the moving blades of the next stage.

The load compressor 160 can also include stages of blades 165 disposed in an axial direction along the rotor shaft 125. For example, the load compressor 160 can include forward stages of blades 165, mid stages of blades 165, and aft stages of blades 165. The forward stages of blades 165 are situated at the front or forward end of the load compressor 160 along the rotor shaft 125. The mid and aft stages of blades are the blades disposed downstream of the forward stages along the rotor shaft 125 where the working fluid is further expanded.

Each of the stages in the load compressor 160 can include rotating blades 165 arranged in a circumferential array about the circumference of the rotor shaft 125 to define moving blade rows extending radially outward from the rotatable shaft. Like the stages for the compressor section 105 and the turbine section 115, the moving blade rows of the load compressor 160 are disposed axially along the rotor shaft 125 in locations that are situated in the forward stages, the mid stages, and the aft stages. In addition, each of the stages can include annular rows of stationary vanes extending radially inward towards rotor shaft 125 in the forward stages, the mid stages, and the aft stages. In one embodiment, the annular rows of stationary vanes can be disposed on the turbine's casing (not illustrated) that surrounds the rotor shaft 125.

In each of the stages, the annular rows of stationary vanes can be arranged with the moving blade rows in an alternating pattern along an axial direction of the rotor shaft 125 parallel with its axis of rotation. In this manner, the moving blades in each stage are cambered to apply work and to turn the flow, while the stationary vanes in each stage are cambered to turn the flow in a direction best suited to prepare it for the moving blades of the next stage.

As described herein, at least one of the rotating components (e.g., blades 130, 135, and 165) in one of the compressor section 105, the turbine section 115, and the load compressor 160 can be formed from a low-density material. Those skilled in the art will appreciate that the number and placement of rotating blades 130, 135 and 165 that include a low-density material can vary by design and application in which the mechanical drive architecture operates. For example, some or all of rotating blades 130, 135 and 165 of a particular section (e.g., the compressor section 105, the turbine section 115, or the load compressor 160) can include a low-density material. In instances where rotating blades 130, 135 and 165 in one or more rows or stages are formed of a low-density material, then rotating blades 130, 135 and 165 in other rows or stages may be formed from a high-density material. By way of example only, in one embodiment, the blades in the forward stages of the compressor section, the aft stages of the turbine section, and/or the forward stages of the load compressor may be made of low-density material, since these blades have longer lengths.

Referring back to FIG. 1, the bearings 140 support the rotor shaft 125 along the drive train. For example, a pair of bearings 140 can support each of the turbine rotor shaft part, the compressor rotor shaft part of the gas turbine, and the load compressor rotor shaft part of rotor shaft 125. In one embodiment, each pair of bearings 140 can support the turbine rotor shaft part, the compressor rotor shaft part of the gas turbine, and the load compressor rotor shaft part at their respective opposite ends of rotor shaft 125. However, those skilled in the art will appreciate that the pair of bearings 140 can support the turbine rotor shaft part, the compressor rotor shaft part of the gas turbine, and the load compressor rotor shaft part at other suitable points.

Moreover, those skilled in the art will appreciate that each of the turbine rotor shaft part, the compressor rotor shaft part of the gas turbine, and the load compressor rotor shaft part of rotor shaft 125 is not limited to support by a pair of bearings 140. The bearing 140 shown between the compressor section 105 and the turbine section 115 (that is, beneath the combustors 110) may be optional; that is, in some configurations, the gas turbine may be readily supported by bearings supporting the compressor section 105 and the turbine section 115 without an intermediate bearing.

In the various embodiments described herein, at least one of bearings 140 can be described as a low-loss bearing including a low-loss lubricant (i.e., “a low-loss lubricant bearing”). In one embodiment, all of the bearings 140 are low-loss lubricant bearings. In such a configuration, a bearing fluid skid 150 having a single fluid (i.e., a low-loss lubricant) is used. Bearings including a low-loss lubricant use a significantly smaller volume of fluid than conventional, high-viscosity oil bearings, thereby permitting the reservoirs, pumps, and other accessories in the bearing fluid skid 150 to be down-sized for the smaller fluid volume. Such an arrangement simplifies the bearing fluid skid 150 and reduces start-up and maintenance costs, when compared to conventional oil bearings.

Additionally, mono-type or hybrid-type low-loss bearings (as described herein) include a roller bearing element as a back-up to the primary bearing unit(s). These back-up bearings increase the length of the rotor shaft 125 connecting the sections of the power train, thereby increasing the manufacturing costs of the rotor shaft 125. Thus, the incumbent costs of mono-type and hybrid-type low-loss bearings (when used in conjunction with low-loss lubricant bearings) are weighed against the output and efficiency benefits afforded by the reduced viscous losses such low-loss bearings provide.

Accordingly, in one embodiment, another of the bearings 140 may be a mono-type low-loss bearing having a very low viscosity fluid. In other embodiments, another of the bearings 140 may be a hybrid-type bearing including a first primary bearing unit supplied with magnetic flux and a second primary bearing unit supplied with a very low viscosity fluid. In some embodiments, it may be desirable to use conventional high viscosity oil bearings with the low-loss lubricant bearings and, optionally, mono-type and/or hybrid-type bearings with very low viscosity fluids. Thus, in some arrangements, a combination of bearing types may be used, in which one or more bearings include very low viscosity fluids, while at least one bearing includes a low-loss lubricant. In such combinations, the bearings 140 having very low viscosity fluids may be mono-type or hybrid-type bearings.

The bearings 140 include fluids supplied by a bearing fluid skid 150, which is illustrated in FIG. 1. The bearing fluid skid 150 is marked with “LLL” (for low-loss lubricant), “A” (for air), “G” (for gas), “F” (for magnetic flux), “S” (for steam), and “O” (for high viscosity, or conventional, oil), although it should be understood that one or a combination of these fluids may be used to supply the multiple bearings 140 in the drive train. In the architectures contemplated herein, the bearings 140 are of a low-loss type—that is, bearings including either a low-loss lubricant or a very low viscosity fluid, such as air, gas, magnetic flux, or steam, as described above. In the present invention, an architecture having at least one bearing with a low-loss lubricant is used.

The bearing fluid skid 150 may include equipment standard for bearing fluid skids, such as reservoirs, pumps, accumulators, valves, cables, control boxes, piping, and the like. The piping necessary to deliver the fluid(s) from the bearing fluid skid 150 to the one or more bearings 140 is represented in the Figures by arrows from the bearing fluid skid 150 to each of the bearings 140. In some instances, it may be possible for the bearing fluid skid 150 to provide two or more different types of fluids (such as oil and one or more of the low-loss lubricants or very low-viscosity fluids described above). Alternately, if two or more different bearing types are used, bearing skids 150 for each fluid type may be employed.

Those skilled in the art will appreciate that the selection of the low-loss bearings used for bearings 140 can vary by design and application in which the mechanical drive architecture operates. For example, some or all of bearings 140 can include low-loss lubricant bearings, alone or in combination with conventional oil bearings. Alternately or in addition, mono-type or hybrid-type low-loss bearings having one or more very low viscosity fluids may be used in conjunction with the low-loss lubricant bearing. In those sections where the rotor shaft is supported by low-loss bearings having a low-loss lubricant or a very low-viscosity fluid, it may be preferred to incorporate low-density materials in the respective section to create a section whose weight is more easily supported and rotated.

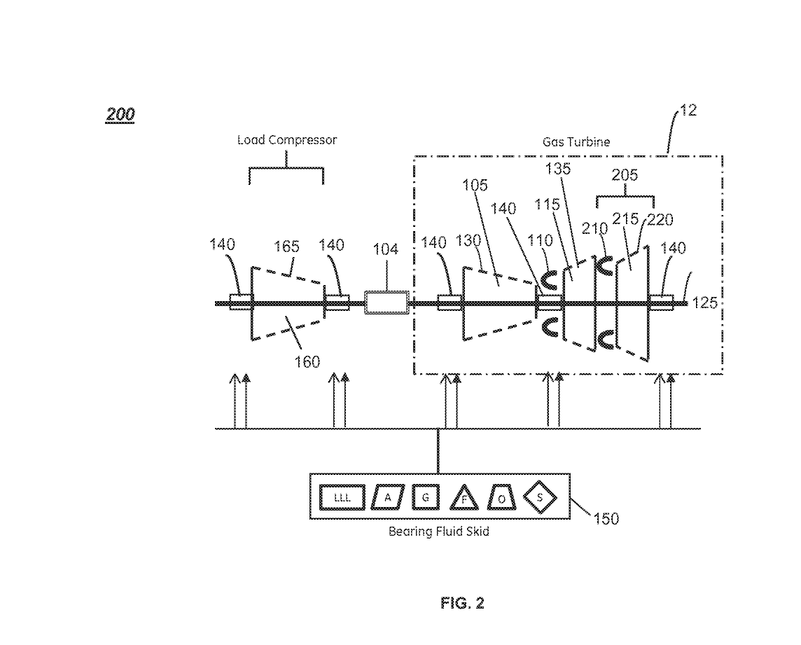

In addition, those skilled in the art will appreciate that, for clarity, the mechanical drive architecture shown in FIG. 1, and those illustrated in FIGS. 2-9, only show those components that provide an understanding of the various embodiments of the invention. Those skilled in the art will appreciate that there are additional components other than those that are shown in these figures. For example, a mechanical drive architecture and/or gas turbine architecture, as described herein, could include secondary components such as gas fuel circuits, a gas fuel skid, liquid fuel circuits, a liquid fuel skid, flow control valves, a cooling system, etc.

In a mechanical drive architecture such as those illustrated herein, which includes multiple bearings, the balance-of-plant (BoP) viscous losses are reduced in each location where a low-loss bearing is substituted for a conventional viscous fluid bearing. Thus, replacing multiple—if not all—of the viscous fluid bearings with low-loss bearings, as described, significantly impacts viscous losses, thereby increasing the outputs of the drive train at a base load of operation and a part load of operation.

The efficiency and output of the drive train architecture may be further improved by using rotating components of larger radial length. The challenge heretofore with producing rotating components of larger lengths has been that their weight makes them incompatible with low-loss bearings. However, the use of low-density materials for one or more of the rotating components permits the fabrication of components of the desired (longer) lengths without a corresponding increase in the airfoil pulls and rotor wheel diameter. As a result, a greater volume of air may be employed in producing motive fluid to drive the gas turbine, and low-loss bearings may be used to support the drive train section in which the low-density rotating components are located.

Below are brief descriptions of the gas turbine-driven mechanical drive architectures illustrated in FIGS. 2-9. Specific gas turbine architectures, which may be employed in the mechanical drive architectures in FIGS. 1-4, are illustrated in FIGS. 5-9. All of these Figures illustrate different types of drive trains that can be implemented for a particular industrial mechanical drive application.

Although each architecture may operate in a different manner than the configuration of FIG. 1, they are similar in that the embodiments in FIGS. 2-9 can have at least one low-density rotating component (e.g., the rotor blades 130, 135 and/or 165 of the compressor section 105, the turbine section 110, and the load compressor 160, respectively). As noted above, some or all of the rotating components 130, 135, 165 can be of a low-density material. With particular reference to blades in the compressor, turbine, or load compressor sections, rotating components of low-density material can be interspersed by stage with rotating components of high-density material.

Similarly, these embodiments can use at least one low-loss lubricant bearing for bearings 140. One, some or all of the bearings 140 can be a low-loss bearing, as long as at least one bearing 140 is a low-loss lubricant bearing. In this manner, bearings of a low-loss lubricant bearing type can be interspersed with other types of bearings, such as oil bearings or low-loss bearings having a very-low viscosity fluid. The low-loss bearings 140 (if not low-loss lubricant bearings) may be mono-type or hybrid-type, as described herein.

Further, the use of low-density rotating components and low-loss lubricant bearings in a drive train of a mechanical drive architecture are not meant to be limited to the examples illustrated in FIGS. 1-9. Instead, these examples are merely illustrative of some of the possible architectures in which the use of low-density rotating components and low-loss lubricant bearings can be implemented in a drive train of a mechanical drive architecture. Those skilled in the art will appreciate that there are many permutations of possible configurations of the examples illustrated herein. The scope and content of the various embodiments are meant to cover those possible permutations, as well as other possible drive train configurations that can be implemented in an industrial mechanical drive application that incorporates a gas turbine.

FIG. 2 is a schematic diagram of a mechanical drive architecture 200 having a front-end drive gas turbine 12 with a reheat section 205. As shown in FIG. 2, the reheat section 205 includes a second combustor section 210 and a second turbine section 215, also referred to as a reheat combustor and reheat turbine, respectively, downstream of the first combustor section 110 and the first turbine section 115. The mechanical drive architecture 200 includes at least one low-loss lubricant bearing 140. Other bearings in the architecture 200 may be mono-type low-loss bearings, hybrid-type low-loss bearings, conventional oil bearings, or combinations thereof, each of the bearings being in fluid communication with the bearing fluid skid 150 (as described above).

In this embodiment, both the turbine section 115 and the reheat turbine section 215 can have rotating components (such as blades 135, 220, respectively), which include at least one rotating component that includes a low-density material. In one embodiment, all or some of the rotating blades 135 and/or 220 in one, some, or all of the turbine stages can include the low-density material. In another embodiment, the rotating components (e.g., blades 130) in the compressor section may include a low-density material. In yet another embodiment, at least one of the compressor section 105 and the turbine section 115 may include rotating components 130, 135 of a low-density material, while the rotating components 220 of the reheat turbine section 215 can be of a different type of material (e.g., a high-density material).

Alternately, the compressor section 105 and the turbine section 115 may include rotating components 130, 135 of a high-density material, while the rotating components 220 of the reheat turbine section 215 can be of a low-density material. If desired, each of the compressor section 105, the turbine section 115, and the reheat turbine 215 may include one or more stages of rotating components 130, 135, 220 of a low-density material. Other rotating components—including rotating components in the load compressor 160—may be made of a low-density material, in addition to, or instead of, the rotating blades 130, 135, 220 described above.

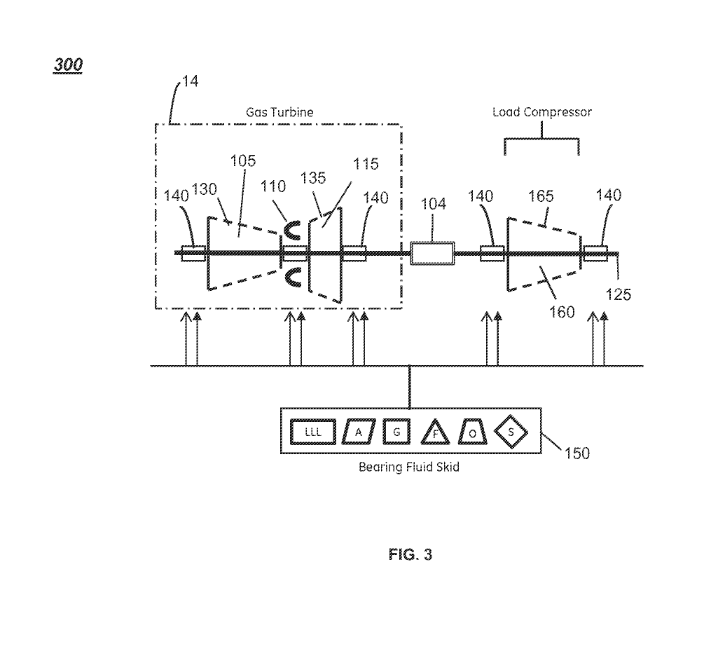

FIG. 3 is a schematic diagram of a mechanical drive architecture 300 having a rear-end drive gas turbine 14, a load compressor 160, and a bearing fluid skid 150. In the architecture 300, the gas turbine 14 is arranged such that the load compressor 160 is coupled, via load coupling 104, to the turbine section 115 of the gas turbine, thus creating a “rear-end drive” gas turbine 14.

As with the architecture 100 shown in FIG. 1, the mechanical drive architecture 300 includes at least one low-loss lubricant bearing 140, which is in fluid communication with the bearing fluid skid 150. Other bearings may be mono-type low-loss bearings, hybrid-type low-loss bearings, conventional oil bearings, or a combination of these bearing types with one or more low-loss lubricant bearings. At least one rotating component (such as compressor blades 130, turbine blades 135, or load compressor blades 165) is made of a low-density material, according to an embodiment of the present invention. Since the individual components of the architecture 300 are the same as those in the architecture 100, reference is made to the previous discussion of FIG. 1, and the discussion of each element is not repeated here.

FIG. 4 is a schematic diagram of a multi-shaft mechanical drive architecture 400 having a rear-end drive gas turbine 14, a torque-altering mechanism 170 (e.g., a gearbox), and a load compressor 160. The gas turbine 14 is coupled to the torque-altering mechanism 170 along a first shaft 125, via a load coupling 104. The load compressor 160 is positioned along a second shaft 126, which is operably connected to the torque-altering mechanism 170. The torque-altering mechanism 170 permits the first shaft 125 to operate at a different rotational speed than the second shaft 126.

The bearings 140 supporting the gas turbine sections and the torque-altering mechanism 170 along the first shaft 125 may include one or more low-loss bearings, as described herein, the bearings 140 being in fluid communication with the bearing fluid skid 150. Similarly, the bearings 140 supporting the load compressor 160 and the torque-altering mechanism 170 along the second shaft 126 may include one or more low-loss bearings, which are in fluid communication with the bearing fluid skid 150. Although a single bearing fluid skid is illustrated, it should be understood that bearing fluid skids 150 may be associated with each shaft 125, 126 and/or each respective fluid being provided. The bearings 140 may be low-loss lubricant bearings, mono-type low-loss bearing, hybrid-type low-loss bearings, conventional oil bearings, or a combination thereof, as long as at least one of the bearings 140 includes a low-loss lubricant.

FIG. 4 shows that the rotating blades 130 of the compressor section 105, the rotating blades 135 of the turbine section 115, and the rotating blades 165 of the load compressor 160 can include one or more stages of low-density blades. This is one possible implementation and is not meant to limit the scope of architecture 400. As mentioned above, there can be any combination of low-density blades with blades made from other materials (e.g., high-density blades), as long as there is at least one rotating blade used in the drive train that includes a low-density material. Alternately or in addition, rotating components other than the blades 130, 135, 165 may be made from low-density material; thus, the disclosure is not limited to an arrangement where only the blades are made from low-density material. Preferably, the low-density rotating components 105, 135, and/or 165 are used in a section of the gas turbine 400 that is supported by bearings 140 that are low-loss bearings and, particularly, low-loss lubricant bearings.

FIG. 5 is a schematic diagram of a multi-shaft gas turbine architecture 500, including a rear-end drive gas turbine 16 having a compressor section 105, a combustor section 110, and a turbine section 115 on a first shaft 310. The gas turbine 16 further includes a power turbine section 305 on a second shaft 315, which is downstream of the turbine section 115. The gas turbine 16 of FIG. 5 may be substituted for the rear-end drive gas turbine 14 in the drive train architecture 300 of FIG. 3 or the drive train architecture 400 of FIG. 4.

In this embodiment, a rear-end drive arrangement is provided, in which the single shaft (as shown in the gas turbine 14 of FIG. 3) has been replaced with a multi-shaft arrangement. In particular, a first single rotor shaft 310 extends through the compressor section 105 and the turbine section 115, while a second single rotor shaft 315, separated from the shaft 310, extends from the power turbine section 305 to the load compressor 160 (not shown, but indicated by the legend “To Load Compressor”).

In operation, the first rotor shaft 310 can serve as the input shaft, while the second rotor shaft 315 can serve as the output shaft. In one embodiment, the output speed of the rotor shaft 315 spins at a constant speed (e.g., 3600 RPMs) to ensure that the load compressor (160) operates at a constant frequency (e.g., 60 Hz), while the input speed of the rotor shaft 310 may be different than that of the rotor shaft 315 (e.g., may be greater than 3600 RPMs).

Bearings 140 can support the various gas turbine sections on the rotor shaft 310 and the rotor shaft 315. In one embodiment, at least one of the bearings 140 can include a low-loss lubricant bearing, as described herein. Other bearings 140 in the gas turbine architecture may be mono-type low-loss bearings, hybrid-type low-loss bearings, conventional oil bearings, or a combination thereof. Regardless of type, the bearings 140 are in fluid communication with the bearing fluid skid 150, as shown, for example, in FIG. 3.

In one embodiment, the power turbine 305 can have at least one rotating component 405 (e.g., a blade) that is made of a low-density material. FIG. 5 shows that the rotating blades 130 of the compressor section 105, the rotating blades 135 of the turbine section 115, and the rotating blades 405 of the power turbine section 305 can include one or more stages of low-density blades. This is one possible implementation and is not meant to limit the scope of architecture 500. As mentioned above, there can be any combination of low-density blades with blades made from other materials (e.g., high-density blades), as long as there is at least one rotating blade used in the drive train that includes a low-density material. Alternately or in addition, rotating components other than the blades 130, 135, 405 may be made from low-density material; thus, the disclosure is not limited to an arrangement where only the blades are made from low-density material. Preferably, the low-density rotating components 105, 135, and/or 405 are used in a section of the gas turbine 500 that is supported by bearings 140 that are low-loss bearings and, particularly, low-loss lubricant bearings.

FIG. 6 is a schematic diagram of a multi-shaft, rear-end drive gas turbine architecture 600 having a power turbine 305 and a reheat section 205. The gas turbine architecture 600 further includes at least one low-loss lubricant bearing 140 and at least one rotating component made of a low-density material in use with the drive train of the gas turbine, according to an embodiment of the present invention. Other bearings 140 may be mono-type low-loss bearings, hybrid-type low-loss bearings, conventional oil bearings, and a combination thereof, as long as at least one bearing is a low-loss lubricant bearing. As with FIG. 5, the gas turbine 18 of FIG. 6 may be substituted for the rear-end drive gas turbine 14 in the drive train architecture 300 of FIG. 3 or the drive train architecture 400 of FIG. 4.

Gas turbine architecture 600 is similar to the one illustrated in FIG. 5, except that the gas turbine 18 includes a reheat section 205 having a reheat combustor section 210 and a reheat turbine section 215. The reheat section 205 is added to the input drive shaft 310. FIG. 6 shows that the rotating blades 130 of the compressor section 105, the rotating blades 135 of the turbine section 115, the rotating blades 220 of the reheat turbine section 215, the rotating blades 405 of the power turbine section 305, and the rotating blades 165 of the load compressor 160 (shown in FIG. 2) can include low-density materials. This is one possible implementation and is not meant to limit the scope of architecture 600.

As mentioned above, there can be any combination of low-density blades with blades that include other materials (e.g., high-density blades), as long as there is at least one rotating component used in the drive train that includes a low-density material. For greater efficiency, the section(s) of the architecture 600 that are supported by low-loss bearings 140 (e.g., low-loss lubricant bearings) include rotating components made of low-density material, wherein at least some of the rotating components are made of low-density material.

FIG. 7 is a schematic diagram of a front-end drive gas turbine architecture 700 having a gas turbine 20 whose architecture includes a stub shaft 620 to reduce the speed of forward stages of a compressor section 605. The gas turbine 20 further includes at least one low-loss lubricant bearing 140 in use with the drive train of the gas turbine, according to an embodiment of the present invention. The gas turbine 20 may be substituted for the front-end drive gas turbine 10 in FIG. 1.

In this embodiment, the compressor section 605 is illustrated with two stages 610 and 615, where stage 610 represents the forward stages of the compressor section 605 and stage 615 represents the mid and aft stages of the compressor section 605. This is only one configuration, and those skilled in the art will appreciate that the compressor section 605 could be illustrated with more stages. In any event, the rotating blades 710 associated with stage 610 are coupled to a stub shaft 620, while the rotating blades 715 of stage 615 and the turbine section 115 are coupled along the rotor shaft 125 that extends to the load compressor 160 (indicated by “To the Load Compressor”). At least one of the forward stages of the compressor 610, the mid and aft stages of the compressor 615, the turbine section 115, and/or the load compressor (160) may include one or more rotating components made of a low-density material. The rotating components of low-density material may be interspersed (e.g., by stage) with rotating components of other materials (e.g., high-density materials).

In one embodiment, the stub shaft 620 can be radially outward from the rotor shaft 125 and circumferentially surround the rotor shaft 125. Bearings 140 are located about the compressor section 605, the turbine section 115, and the load compressor (160) to support the stub shaft 620 and the rotor shaft 125. All, some, or at least one of the bearings 140 in this configuration may be low-loss bearings having a low-loss lubricant, as described herein. Other bearings in the architecture 700 may be mono-type low-loss bearings, hybrid-type low-loss bearings, conventional oil bearings, or a combination thereof. In one embodiment, low-loss lubricant bearings may be used in one or more locations, while low-loss bearings having a very low viscosity fluid may be used in other locations. Such low-loss bearings are particularly well-suited for supporting those sections of the architecture 700 having rotating components made of low-density materials.

In operation, the rotor shaft 125 enables the turbine section 115 to drive the load compressor (160, as shown in FIG. 1). The stub shaft 620 can rotate at a slower operational speed than rotor shaft 125, which causes the blades 710 of the forward stage 610 to rotate at a slower rotational speed than the blades 715 in the mid and aft stages of stage 615 (which are coupled to the rotor shaft 125). In another embodiment, the stub shaft 620 can be used to rotate the blades 710 of stage 610 in a different direction than the blades 715 of stage 615. Having the rotating blades 710 of stage 610 rotate at a slower rotational speed and/or in a different direction than the blades 715 of stage 615 can enable the stub shaft 620 to slow down the rotational speed of the forward stages of blades (e.g., to approximately 3000 RPMs), while the rotor shaft 125 can maintain the rotational speed of the rotating blades 135 of the turbine section 115, and thus the speed of the load compressor 160, for operation at a constant speed (e.g., 3600 RPMs).

Slowing down the rotational speed of the forward stages of blades 710 in stage 610 in relation to the mid and aft stages of blades 715 in stage 615 facilitates the use of larger blades in the forward stages. As a result of their larger size, the airflow (or gas flow) through the compressor section 605 is increased over a conventional compressor, which means that more airflow will flow through the gas turbine20. More airflow through gas turbine 20 translates to more output.

Further, because the rotating blades 710 of the forward stages can operate at a reduced speed, attachment stresses that typically arise in these stages can be mitigated. As a result, if a compressor manufacturer desires to continue using blades of a high-density material in the forward stages, the slower rotational speed of the forward stage 610 permits the rotating blades of the forward stages to be made in larger sizes and still remain within prescribed AN² limits. U.S. patent application Ser. No. ______, entitled “MULTI-STAGE AXIAL COMPRESSOR ARRANGEMENT”, Attorney Docket No. 257269-1, filed concurrently herewith and incorporated by reference herein, provides more details on the use of a stub shaft to attain a slower rotational speed at the forward stages of a compressor.

FIG. 8 is a schematic diagram of a gas turbine architecture 800 having a front-end drive gas turbine 22 with a reheat section 205. The architecture 800 further includes a stub shaft 620 to reduce the speed of forward stages of a compressor in the gas turbine 22, at least one low-loss bearing including a low-loss lubricant, and at least one rotating component made of a low-density material, according to an embodiment of the present invention. The low-loss bearing including a low-loss lubricant may be used in one or more locations in conjunction with mono-type or hybrid-type bearings having a very-low viscosity fluid and/or conventional high viscosity oil bearings. As previously discussed, the bearings 140 are in fluid communication with a bearing fluid skid 150, as illustrated in FIG. 2.

In this embodiment, the reheat section 205 can be added to the configuration illustrated in FIG. 7. In this arrangement, the rotating blades 705 and 710 in stages 610 and 615, respectively, of the compressor section 605, the rotating blades 135 of the turbine section 115, the rotating blades 220 of the reheat turbine section 215, and/or the rotating blades (165) of the load compressor (160) can include blades that are made of a low-density material.

Again, this is one possible implementation and is not meant to limit the scope of architecture 800. For example, there can be any number of low-density blades in combination with blades of other types of material (e.g., high-density materials) in the drive train, as long as there is at least one rotating component that includes a low-density material. Alternately, or in addition, rotating components other than the blades may be made of low-density materials in one or more sections. The gas turbine 22 of FIG. 8 may be substituted for the gas turbine 12 in those drive train architectures having a gas turbine with a reheat section 205, including the drive train architecture 200 of FIG. 2.

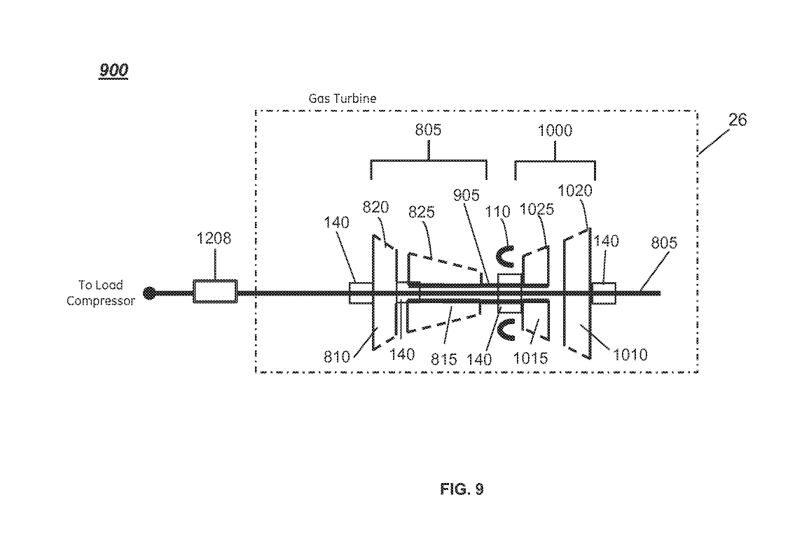

FIG. 9 is a schematic diagram of a gas turbine architecture 900 having a multi-shaft gas turbine 26 with a low-speed spool 805 and a high-speed spool 905. The gas turbine 26 further includes at least one low-loss bearing 140 having a low-loss lubricant in use with the drive train of the gas turbine, according to an embodiment of the present invention. The gas turbine 26 of FIG. 9 may be substituted for the front-end drive gas turbine 10 in the drive train architecture 100 shown in FIG. 1.

In this embodiment, a compressor 805 comprises a low pressure compressor 810 and a high pressure compressor 815 separated from the low pressure compressor 810 by air. In addition, gas turbine architecture 900 comprises a turbine 1000 that comprises a low pressure turbine 1010 and a high pressure turbine 1015 separated from the low pressure turbine 1010 by air. The low-speed spool 805 can include low pressure compressor 810, which is driven by low pressure turbine 1010. The high-speed spool 905 can include the high pressure compressor 815, which is driven by high pressure turbine 1015. In this architecture 900, the low-speed spool 805 can drive the load compressor (160, as indicated by “To Load Compressor”) at a desired rotational speed (e.g., 3600 RPMs) to operate at a desired frequency (e.g., 60 Hz), while the high-speed spool 905 can operate at a rotational speed that is greater than that of the low speed spool (e.g., greater than 3600 RPMs), forming a dual spool arrangement.

In FIG. 9, at least one of the bearings 140 that support the drive train 900 can be a low-loss bearing including a low-loss lubricant. The low-loss lubricant bearing may be used in conjunction with mono-type or hybrid-type low-loss bearings having a very-low viscosity fluid and/or conventional high viscosity oil bearings. The bearings 140 are in fluid communication with at least one bearing fluid skid 150, as shown in FIG. 1, for example.

FIG. 9 shows that the rotating blades 820, 825 of the compressor sections 810, 815, the rotating blades 1020, 1025 of the turbine sections 1010, 1015, and the rotating blades (165) of the load compressor (160) can be made of a low-density material, as indicated by the dashed lines. This is one possible implementation and is not meant to limit the scope of the architecture 900. Again, there can be any combination of low-density rotating components (e.g., blades) in use with rotating components (e.g., blades) made of different compositions (e.g., high-density materials), as long as there is at least one rotating component used in the drive train that includes a low-density material. In at least one embodiment, the low-density materials are used in one or more rotating components in the section(s) of the drive train architecture 900 supported by low-loss bearings, particularly low-loss lubricant bearings.

Optionally, a torque-altering mechanism 1208—such as a gearbox, torque-converter, gear set, or the like—may be positioned along the low-speed spool 805 between the gas turbine 26 and the load compressor (not shown, but indicated by “To Load Compressor”). When a torque-altering mechanism 1208 is included, the torque-altering mechanism 1208 provides output correction, such that the low-speed spool 805 can operate at a rotational speed greater than 3600 RPMs and drive the load compressor at a lower rotational speed of 3600 RPMs and still achieve an operating output of 60 Hz. Such an arrangement may be desirable for some mechanical drive arrangements.

As described herein, embodiments of the present invention describe various mechanical drive architectures that can use low-loss lubricant bearings and low-density materials as part of a drive train used for industrial applications. These gas turbine-driven mechanical drive architectures with low-loss lubricant bearings and low-density materials can deliver a high airflow rate in comparison to other drive trains that use conventional oil bearings and high-density materials. In addition, this delivery of a higher airflow rate occurs while reducing viscous losses that are typically introduced into the drive train through the use of high viscosity oil-based bearings. The use of the low-loss lubricant bearings can translate into a reduction in maintenance costs since many of the components pertaining to the high viscosity oil bearings can be removed or downsized.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises,” “comprising,” “includes,” “including,” and “having,” when used in this specification, specify the presence of stated features, integers, steps, operations, elements, and/or components, but do not preclude the presence or addition of one or more other features, integers, steps, operations, elements, components, and/or groups thereof. It is further understood that the terms “front” and “back” are not intended to be limiting and are intended to be interchangeable where appropriate.

While the disclosure has been particularly shown and described in conjunction with a preferred embodiment thereof, it will be appreciated that variations and modifications will occur to those skilled in the art. Therefore, it is to be understood that the appended claims are intended to cover all such modifications and changes as fall within the true spirit of the disclosure.

What is claimed is:

1. A mechanical drive architecture, comprising:
a gas turbine having a compressor section, a turbine section, and a combustor section operatively coupled to the compressor section and the turbine section;
a load compressor driven by the gas turbine engine;
a rotor shaft extending through the compressor section and the turbine section of the gas turbine engine and the load compressor; and
a plurality of bearings to support the rotor shaft within the gas turbine and the load compressor, wherein at least one of the bearings is a low-loss bearing including a low-loss lubricant;
wherein the compressor section, the turbine section, and the load compressor each have a plurality of rotating components, at least one of the rotating components in at least one of the compressor section, the turbine section, and the load compressor including a low-density material.

2. The mechanical drive architecture of claim 1, further comprising at least one low-loss bearing including a very low viscosity fluid.

3. The mechanical drive architecture of claim 1, further comprising at least one conventional oil bearing.

4. The mechanical drive architecture of claim 1, wherein the rotor shaft includes a single shaft arrangement.

5. The mechanical drive architecture of claim 1, further comprising a reheat section operatively coupled to the turbine section along the rotor shaft, the reheat section having a reheat combustor section and a reheat turbine section with a plurality of rotating components; wherein at least one of the rotating components in the compressor section, the turbine section, the load compressor, and the reheat turbine section includes the low-density material.

6. The mechanical drive architecture of claim 1, wherein the gas turbine comprises a rear-end drive gas turbine.

7. The mechanical drive architecture of claim 1, further comprising a load coupling element for coupling the load compressor to the gas turbine along the rotor shaft.

8. The mechanical drive architecture of claim 1, wherein the rotor shaft includes a multi-shaft arrangement having a first rotor shaft extending through the compressor section and the turbine section and a second rotor shaft extending through the load compressor, each of the first rotor shaft and the second rotor shaft being supported by the plurality of bearings.

9. The mechanical drive architecture of claim 8, further comprising a gearbox assembly configured to rotate the rotating components in the gas turbine at a different rotational speed than the rotating components in the load compressor.

10. The mechanical drive architecture of claim 8, further comprising a power turbine section coupled to the second rotor shaft to drive the load compressor; wherein the power turbine section has a plurality of rotating components, at least one of the rotating components in the compressor section, the turbine section, the load compressor, and the power turbine section including the low-density material.

11. The mechanical drive architecture of claim 10, further comprising a reheat section operatively coupled to the turbine section along the first rotor shaft, the reheat section having a reheat combustor section and a reheat turbine section with a plurality of rotating components; wherein at least one of the rotating components in the compressor section, the turbine section, the load compressor, the power turbine section, and the reheat turbine section includes the low-density material.

12. The mechanical drive architecture of claim 1, wherein the compressor section includes forward stages distal to the combustor section, aft stages proximate to the combustor section, and mid stages disposed therebetween, each of the forward stages, the mid stages, and the aft stages have a plurality of rotating components; wherein at least one of the rotating components in the forward stages, the mid stages, and the aft stages of the compressor section, the turbine section, and the load compressor includes the low-density material; and wherein the mechanical drive architecture further comprises a stub shaft radially outward of the rotor shaft and extending through the forward stages, such that the rotating components of the forward stages arranged about the stub shaft operate at a slower rotational speed than the rotating components of the mid and aft stages arranged about the rotor shaft.

13. The mechanical drive architecture of claim 12, wherein the plurality of bearings includes stub shaft bearings to support the stub shaft, at least one of the stub shaft bearings including a low-loss lubricant bearing.

14. The mechanical drive architecture of claim 1, wherein the compressor section includes a low pressure compressor section and a high pressure compressor section, and the turbine section includes a low pressure turbine section and a high pressure turbine section; wherein the high pressure turbine section drives the high pressure compressor section, and the low pressure turbine section drives the low pressure compressor section.

15. The mechanical drive architecture of claim 14, wherein each of the low pressure compressor section, the high pressure compressor section, the low pressure turbine section, and the high pressure turbine section includes a plurality of rotating components; and wherein at least one of the rotating components of the low pressure compressor section, the high pressure compressor section, the low pressure turbine section, the high pressure turbine section, and the load compressor includes the low-density material.

16. The mechanical drive architecture of claim 14, wherein the rotor shaft includes a dual spool arrangement having a low-speed spool and a high-speed spool, the low-speed spool including the low pressure turbine section and the low pressure compressor section, and the high-speed spool including the high pressure turbine section and the high pressure compressor section.

17. The mechanical drive architecture of claim 16, wherein the low speed spool and the high speed spool are supported by the plurality of bearings, at least one of the bearings including a low-loss lubricant bearing.
